(19) United States
(12) Patent Application Publication
(10) Pub. No.: US 2019/0356037 A1
(43) Pub. Date: Nov. 21, 2019

(54) DIRECTIONAL ANTENNA FOR USE BEHIND A TV

(71) Applicant: BARKAN MOUNTS LTD, Tel-Aviv (IL)

(72) Inventor: Shahar BARKAN, Tel-Aviv (IL)

(21) Appl. No.: 16/528,660

(22) Filed: Aug. 1, 2019

Related U.S. Application Data
(63) Continuation-in-part of application No. 15/889,254, filed on Feb. 6, 2018.

(51) Int. Cl. H01Q 1/22; H01Q 1/36; H01Q 13/08

(52) U.S. Cl. CPC H01Q 1/22; H01Q 13/085; H01Q 1/36

(57) ABSTRACT

A directional antenna, including an antenna design configured to receive television or radio broadcast signals while positioned behind a screen that blocks reception of the broadcast signals, wherein the antenna design is configured to be attached directly or indirectly to the screen and receive broadcast signals from a direction perpendicular to the signals blocked by the screen.

### RELATED APPLICATIONS

This application is a continuation in part of application Ser. No. 15/889,254 filed on Feb. 6, 2018, the disclosure of which is incorporated herein by reference.

### TECHNICAL FIELD

The present invention relates to a directional antenna that is located between a screen and a wall to overcome reception interference by the screen and the wall.

### BACKGROUND

In recent years the classic cathode ray tube (CRT) computer and television screens have generally been replaced by thin screens based on liquid crystal display (LCD) or light emitting diode (LED) technology. The newer screens are much lighter than the older CRT screens and can conveniently be hung directly on a wall with an appropriate mounting interface also referred to as a TV wall mount or wall mount.

Additionally, many television screens come with a built in decoder that can decode radio and/or television broadcasts (e.g. Digital Video Broadcasting—Terrestrial (DVB-T)). Typically to ensure proper reception an antenna may be mounted near the television screen, for example on the wall near the TV wall mount and connected by a cable to the television screen.

Typically both the TV wall mount and the antenna are made from metal (e.g. soft steel) and both need to be mounted on the wall at about the same location. However each one is designed differently and serves a different purpose so neither can be omitted.

A standard wall mount cannot serve as an antenna since the metal structure is not designed to enhance/receive radio and/or TV reception and would result in limited reception. Additionally, the wall and the television may interfere with reception of the antenna. Therefore specific designs need to be used to enhance reception.

### SUMMARY

An aspect of an embodiment of the disclosure relates to a directional antenna that is designed to provide good reception when positioned behind a screen, e.g. between the screen and a wall. The antenna receives radio or television broadcasts from a direction perpendicular to the signals blocked by the screen or wall, so that the screen and wall do not interfere with the reception of the antenna.

In an exemplary embodiment of the disclosure, the antenna is in the form of a specific antenna design to enable directional reception. The antenna design may be attached to the back of the screen, to the wall behind the screen or as part of a wall mount for supporting the screen.

In some embodiments the antenna design is in the form of a Meander line antenna. Alternatively, the antenna design may be in the form of a Vivaldi antenna or other directional antenna forms.

There is thus provided according to an exemplary embodiment of the disclosure, a directional antenna, comprising:

An antenna design configured to receive television or radio broadcast signals while positioned behind a screen that blocks reception of the broadcast signals;

Wherein the antenna design is configured to be attached directly or indirectly to the screen and receive broadcast signals from a direction perpendicular to the signals blocked by the screen.

In an exemplary embodiment of the disclosure, the antenna design is a Meander line antenna confined to a single plane. Optionally, the antenna design includes an opening part with a cross shape formed by an intersections of two lines. In an exemplary embodiment of the disclosure, one of the lines extends from the opening part and is folded to form an elongated series of a repetitive pattern. Optionally, the repetitive pattern is shaped as a polygonal spiral that is rotationally symmetrical. In an exemplary embodiment of the disclosure, the repetitive pattern is repeated multiple times. Optionally, the antenna design is configured to be attached directly to the back of a screen. Alternatively, the antenna design is configured to be attached directly to the wall behind a screen. Further alternatively, the antenna design is configured to be positioned between a wall and a screen. In an exemplary embodiment of the disclosure, the antenna design is configured to be attached to a wall as part of a mounting base of a wall mount for supporting a screen. Optionally, the antenna design is configured to be attached to a screen as part of a screen interface frame of a wall mount for supporting a screen. In an exemplary embodiment of the disclosure, the antenna design is formed by folding a line of metal. Alternatively, the antenna design is formed by cutting out portions from a flat sheet of metal. In an exemplary embodiment of the disclosure, a cable is attached to the antenna design to provide a signal from the antenna to the screen or to a television convertor or television receiver. Optionally, the antenna design is configured to be attached to the back of a screen and extend outward perpendicular to the back of the screen.

In an exemplary embodiment of the disclosure, the antenna design is configured to be attached to a screen as part of an arm of a wall mount for supporting a screen. Optionally, the antenna design is a Vivaldi antenna provided as a planar sheet of metal forming a frame surrounding a central cut out portion forming a void. In an exemplary embodiment of the disclosure, the frame is essentially rectangular and includes two elongated arc shaped sides facing each other wherein in the center the arc shaped sides are almost tangent and the distance between the arc shaped sides increases when parting from the center toward the top or bottom edges of the frame. Optionally, the frame includes one or more inward teeth shaped protrusions, protruding from the frame into the void.

There is further provided according to an exemplary embodiment of the disclosure, a method of receiving television or radio broadcast signals, comprising:

Attaching a directional antenna directly or indirectly to a back of a screen that blocks reception of the signals;

Wherein the directional antenna has an antenna design that is configured to receive broadcast signals from a direction perpendicular to the signals blocked by the screen.

In an exemplary embodiment of the disclosure, the antenna design is configured to be attached directly to the back of a screen. Alternatively, the antenna design is configured to be attached directly to the wall behind a screen. Further alternatively, the antenna design is configured to be positioned between a wall and a screen. Optionally, the antenna design is configured to be attached indirectly to a screen as part of a wall mount that supports the screen.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear. It should be noted that the elements or parts in the figures are not necessarily shown to scale and element or part may be relatively larger or smaller than actually shown.

FIG. 1 is a schematic illustration of a wall mount that also serves as an antenna, according to an exemplary embodiment of the disclosure;

FIG. 2 is a schematic illustration of an alternative wall mount that also serves as an antenna, according to an exemplary embodiment of the disclosure;

FIG. 3 is a schematic illustration of an alternative wall mount that also serves as an antenna, according to an exemplary embodiment of the disclosure;

FIG. 4 is a schematic illustration of an alternative wall mount that also serves as an antenna, according to an exemplary embodiment of the disclosure;

FIG. 5 is a schematic illustration of an alternative wall mount that also serves as an antenna, according to an exemplary embodiment of the disclosure;

FIG. 6A is a schematic illustration of an antenna design that serves as a directional antenna, according to an exemplary embodiment of the disclosure;

FIG. 6B is a schematic illustration of a deployed meander line antenna design on the back of a screen, according to an exemplary embodiment of the disclosure;

FIG. 7A is a schematic illustration of a back view of an antenna design that serves as a directional antenna, according to an exemplary embodiment of the disclosure;

FIG. 7B is a schematic illustration of a front view of antenna design that serves as a directional antenna, according to an exemplary embodiment of the disclosure;

FIG. 7C is a schematic illustration of antenna design deployed on the back of a screen, according to an exemplary embodiment of the disclosure.

### DETAILED DESCRIPTION

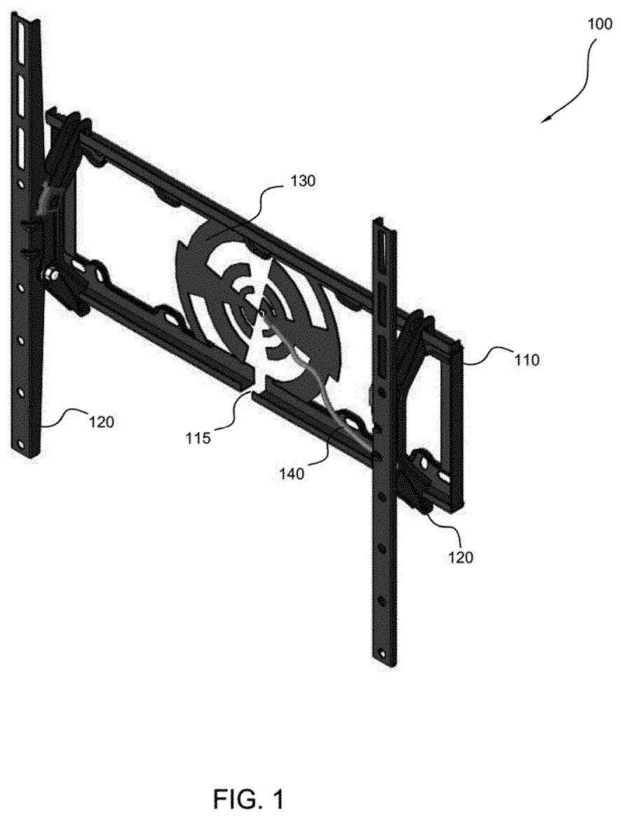

FIG. 1 is a schematic illustration of a wall mount 100 that also serves as an antenna, according to an exemplary embodiment of the disclosure. Wall mount 100 includes a mounting base (e.g. a wall Plate) 110 in the form of a frame that can be attached to a wall and one or more screen interfaces 120 that are provided to be connected to the back of a television screen to hang the television screen from mounting base 110.

In an exemplary embodiment of the disclosure, a metallic antenna design 130 is confined within the mounting base 110, so that it does not increase the size of the wall mount 100. Optionally, the antenna design 130 is cast or cut as an integral part of the mounting base 110 or it may be an independent piece of metal that is coupled to the mounting base 110 (e.g. with clips or screws). The antenna design 130 is shaped to provide optimal reception as an antenna for receiving television broadcasts and it may also provide structural strength to the mounting base 110. In some embodiments of the disclosure, the antenna design 130 is secured to the wall, for example with screws or nails through the antenna design 130 thus making the connection of the mounting base 110 to the wall more secure. Optionally, the mounting base 110 is formed from metal and it enhances reception of the antenna design 130 due to the contact of the metal of the mounting base 110 with the metal of the antenna design 130.

In an exemplary embodiment of the disclosure, the mounting base 110 serves as an integral part of the antenna and is cut forming a gap 115 in the frame of the mounting base 110 to enhance reception of the antenna, for example by matching a gap in the antenna design. Optionally, a cable 140 is attached to the antenna design 130, for example approximately at the center of the antenna design 130 to transfer signals received by the antenna design 130 to the television screen.

In summary, parts of the wall mount 100 are altered to serve also as an antenna, wherein the metal of the wall mount 100 enhances reception of the antenna, and the design of the antenna may enhance the strength of the structure of the wall mount 100. Likewise the design of the antenna is confined within the contour of the wall mount 100 so that the volume/size of wall mount is not enlarged as a result of also serving as an antenna.

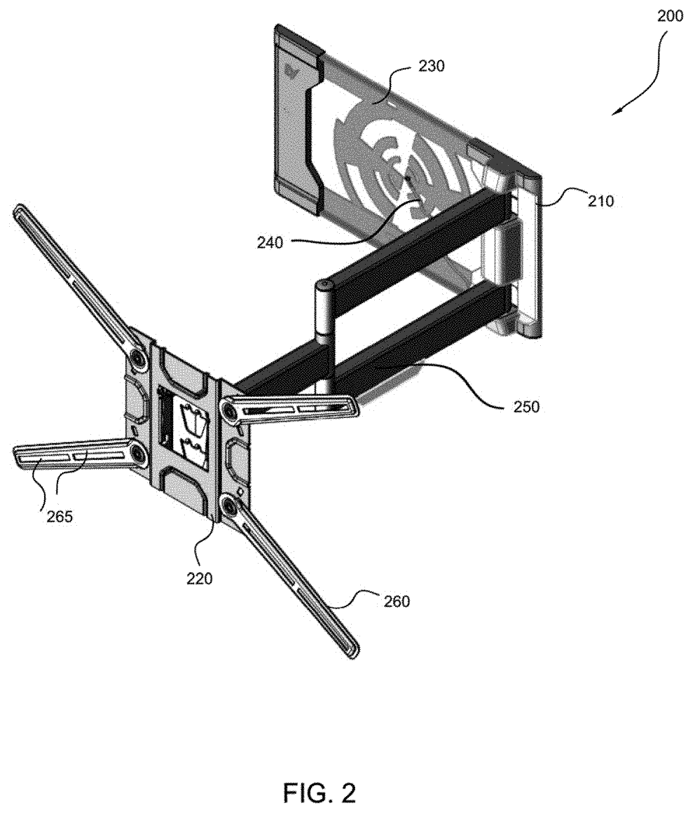

FIG. 2 is a schematic illustration of a wall mount 200 that also serves as an antenna, according to an exemplary embodiment of the disclosure. Wall mount 200 is another example of a wall mount with an integrated antenna. Wall mount 200 includes a mounting base (e.g. a wall Plate) 210 in the form of a frame with an antenna design 230 integrated therein as in wall mount 100 (e.g. provided as an integral part or attached to the mounting base 210). Optionally, a cable 240 is attached to antenna design 230 (e.g. approximately at the center) to connect to the television screen.

In an exemplary embodiment of the disclosure, wall mount 200 includes a rotatable support arm 250 (e.g. with single or double joints) that extends from mounting base 210 to support the television screen and provide rotational freedom. Optionally, a screen interface plate 220 (e.g. a VESA Plate) is attached to an end of the rotatable support arm 250 with screen interface arms 260 rotatably attached to the screen interface plate 220 to hold the television screen. The screen interface arms 260 include slits 265 for positioning screws to couple the screen interface arms 260 to the television screen.

As with wall mount 100 the antenna design 230 is positioned in the frame of mounting base 210 to enhance stability of the wall mount 200 and to enhance reception of the antenna.

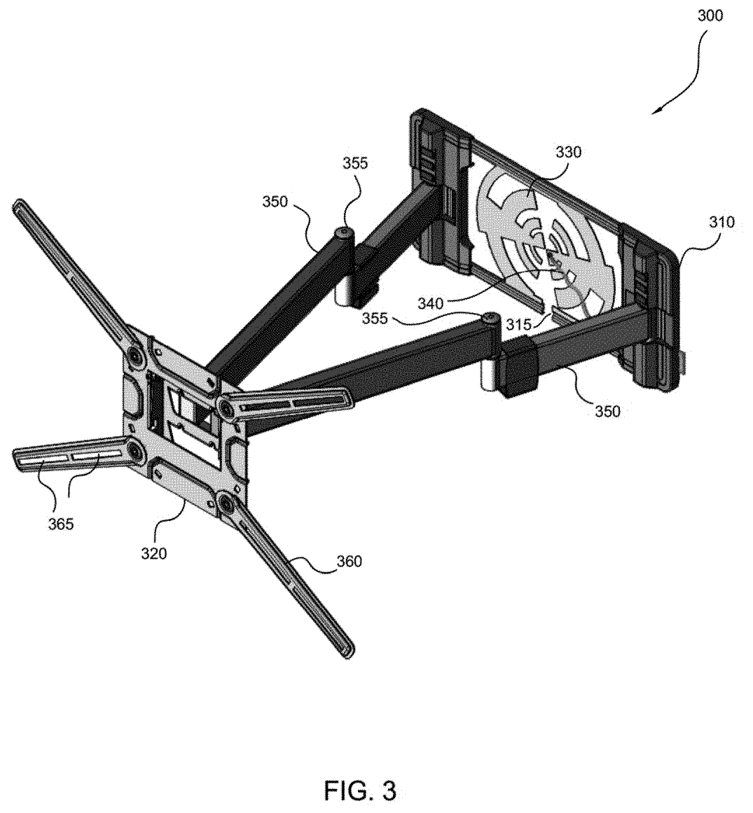

FIG. 3 is a schematic illustration of a wall mount 300 that also serves as an antenna, according to an exemplary embodiment of the disclosure. Wall mount 300 is another example of a wall mount with an integrated antenna. Wall mount 300 includes a mounting base 310 in the form of a frame with an antenna design 330 integrated therein as in wall mount 100 (e.g. provided as an integral part or attached to the mounting base 310). Optionally, a cable 340 is attached to antenna design 330 (e.g. approximately at the center) to connect to the television screen.

In an exemplary embodiment of the disclosure, wall mount 300 includes two foldable support arms 350 (e.g. with single or double joints) that extend from opposite sides of wall mount frame 310 to support the television screen. Optionally, wall mount 300 includes a tightening screw 355 on each of the foldable support arms 350 to lock the position of the foldable support arm 350. In an exemplary embodiment of the disclosure, a screen interface plate 320 is attached to an end of the foldable support arms 350 with screen interface arms 360 rotatably attached to the screen interface plate 320 to hold the television screen. The screen interface arms 360 include slits 365 for positioning a screw to couple the screen interface arms 360 to the television screen.

As with wall mount 100 the antenna design 330 is integrated into the frame of mounting base 310 to enhance stability of the wall mount 300 and to enhance reception of the antenna. Optionally, the frame of mounting base 310 is cut forming a gap 315 in the mounting base 310 to enhance reception of the antenna.

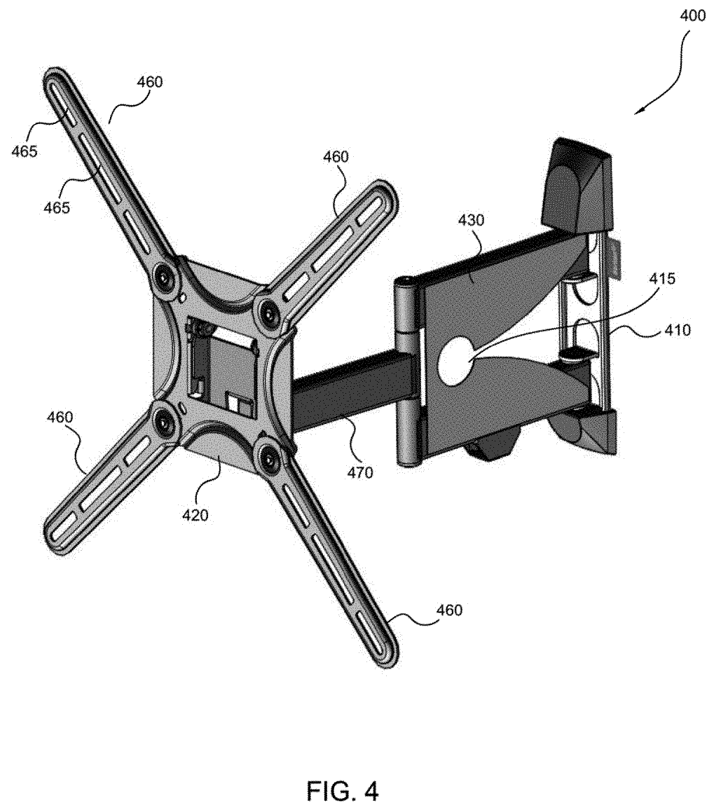

FIG. 4 is a schematic illustration of a wall mount 400 that also serves as an antenna, according to an exemplary embodiment of the disclosure. Wall mount 400 includes a mounting base 410 for attaching to the wall. Optionally, an antenna design support arm 430 is rotatably coupled to mounting base 410. The antenna design support arm 430 is shaped as an antenna and serves as an arm supporting a television screen and as an antenna to receive television transmissions. Optionally, antenna design support arm has a cut out portion forming a gap 415 in the center to enhance transmission reception. Likewise a cable (not shown) may be connected to the antenna design support arm 430 to transfer a received signal to the television screen.

In an exemplary embodiment of the disclosure, an extension arm 470 extends from antenna support arm 430 to hold a screen interface plate 420. The screen interface plate 420 includes screen interface arms 460 that are rotatably attached to the screen interface plate 420 to adjust and hold the television screen. The screen interface arms 460 include slits 465 for positioning screws or pins to couple the screen interface arms 460 to the television screen.

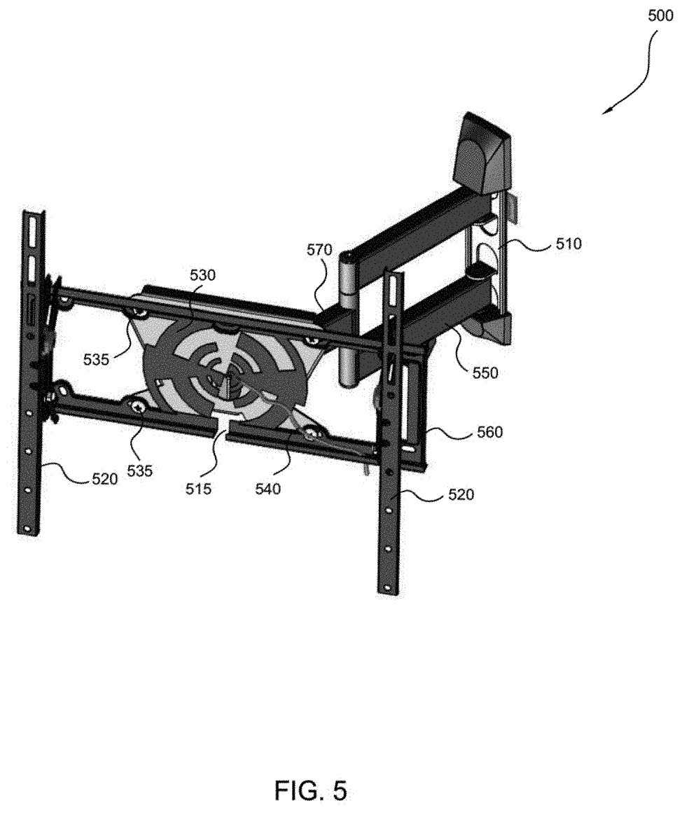

FIG. 5 is a schematic illustration of a wall mount 500 that also serves as an antenna, according to an exemplary embodiment of the disclosure. Wall mount 500 includes a mounting base 510 for attaching wall mount 500 to the wall. A support arm 550 is rotatably connected to the mounting base 510. Optionally, a frame support arm 570 is provided to hold a screen interface frame 560 and is coupled (rotatably or not rotatably) to support arm 550.

In an exemplary embodiment of the disclosure, one or more screen interfaces 520 are provided to be connected to the back of a television screen to hang the television screen from screen interface frame 560. Optionally, as in mounting base 110 of wall mount 100 screen interface frame 560 includes an antenna design 530 that serves as an antenna for receiving television signals. The antenna design 530 may be an integral part of the screen interface frame 560 or may be connected for example with clips or screws, nuts and bolts 535 or other means.

In an exemplary embodiment of the disclosure, frame support arm 570 is attached either directly to the screen interface frame 560 or is attached to antenna design 530 that is attached to screen interface frame 560.

In an exemplary embodiment of the disclosure, a cable 540 may be coupled to the antenna design 530 to provide a received signal from the antenna design 530 to an antenna socket of the television screen.

In some embodiments of the disclosure, screen interface frame 560 may be cut to form a gap 515 (e.g. matching gaps in antenna design 530) to enhance reception by antenna design 530. Likewise antenna design 530 may be connected to screen interface frame 560 with multiple connectors to strengthen the structure of screen interface frame 560.

In summary the above embodiments include wall mounts having an antenna as part of a mounting base, part of a support arm or part of a screen interface that is held by a support arm. Alternatively, other parts and positions of the wall mount may be structured as an antenna. In an exemplary embodiment of the disclosure, the antenna is confined within a frame or serves independently as a part of the wall mount.

Likewise a wall mount with an antenna in multiple positions may be provided, for example having the screen interface frame 560 and the support arm 550 or 430 both designed as antennas.

In some embodiments of the disclosure, the entire wall mount may be made from metal to enhance reception. Alternatively, some of the wall mount parts (e.g. excluding the antenna part) may be made from other materials such as rubber or plastic to isolate signals received by the antenna and prevent signal noise.

Analog and digital television broadcasts cover a wide range of frequencies, for example 40 MHz to about 900 MHz. optionally, the size and thickness of the antenna part of the wall mount may be selected to match a desired frequency range, for example the antenna design part may be made from a thicker metal or thinner metal than the rest of the wall mount or the antenna design part may be enlarged relative to a wall mount that does not serve as an antenna. Additionally, the antenna part of the wall mount may be made from a different metal than the rest of the wall mount, for example from copper.

Television broadcasts are generally transmitted from a transmission tower and propagate in all directions. Optionally, the antenna design for use with the wall mount is selected to optimize reception of desired frequencies. In some embodiments of the disclosure, multiple designs may be used together to optimize reception.

Television transmissions have vertical polarization, therefore an antenna with vertical polarization will have better reception than other antennas. An antenna with circular polarization will only receive half of the intensity of the transmission and an antenna with horizontal polarization will not receive a signal at all. Additionally a good television antenna generally has an impedance that is close to 75 Ohm. Optionally, the impedance may be controlled by adding a matching circuit into the antenna design used for the wall mount.

Some common antenna designs for television reception include:

1. A bow tie antenna;

2. A log-periodic tooth antenna—for example as shown in FIGS. 1, 2, 3 and 5;

3. A dipole antenna;

4. A monopole antenna;

5. A slot antenna;

6. A loop antenna;

7. A Vivaldi antenna—for example as shown in FIG. 4.

Optionally, the antenna used in the wall mount may be comprised from one or more of the above designs.

In an exemplary embodiment of the disclosure, the wall mount is provided to a user as a constructible kit, which can be coupled to a wall and assembled by a user for hanging a television screen on the wall.

In some embodiments of the disclosure, the television and/or wall interfere with the reception of the antenna and completely or partially block reception of television or radio broadcast signals. Therefore a directional antenna having an antenna design that is configured to receive television or radio broadcast signals from a direction perpendicular to the signals blocked by the screen is used to form the antenna. Thus the antenna design is configured to receive signals from the sides behind the screen that are not blocked by the screen. Optionally, the antenna design can replace the antenna designs described above (e.g. antenna design 130, 230, 330, 430 or 530).

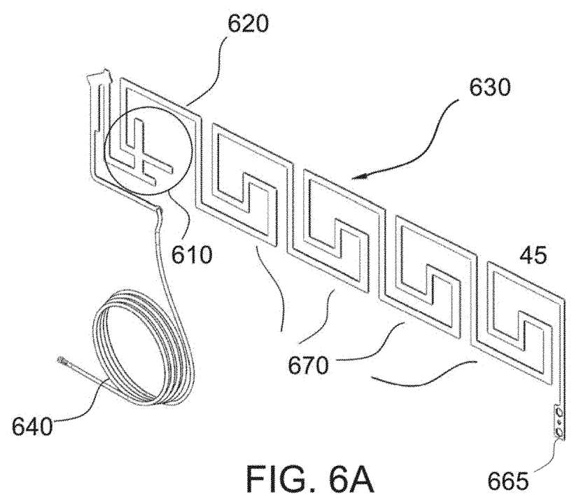

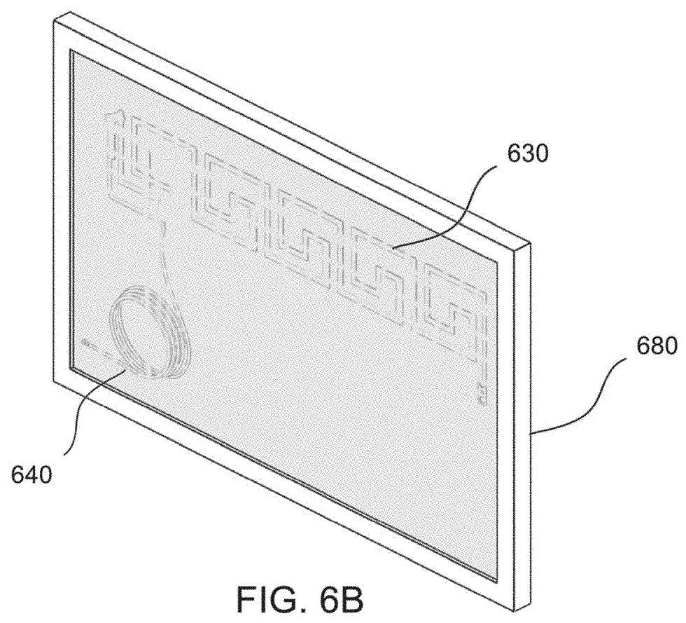

FIG. 6A is a schematic illustration of an antenna design 630 that serves as a directional antenna, according to an exemplary embodiment of the disclosure. Optionally, antenna design 630 may be installed in mounting base 110, 210, 310 to be mounted parallel to the surface of the wall or in screen interface frame 560 to be mounted parallel to the back of the television. Alternatively, antenna design 630 may be used independent of a wall mount (e.g. 100, 200, 300, 500) and installed directly behind the screen (e.g. on the back of a screen or standing on a base or legs between a screen and a wall and not wall mounted).

In an exemplary embodiment of the disclosure, antenna design 630 is a rigid Meander line antenna formed as a line of metal folded to form the antenna and confined to a single plane. Antenna design 630 includes an opening part 610 with a cross shape formed by an intersection of two lines. One of the lines extends from the opening part 610 and is folded to form an elongated series of repetitive patterns 670 all in a single plane. Optionally a connection point 665 is allocated at an end of the line for attaching the antenna design 630 to a wall, wall mount or the back of a screen. The attaching point may include holes for inserting a screw, nail or other attaching means, for example to attach the antenna 630 to the screen. Optionally, at another end of the antenna design 630 a cable 640 is attached, to provide a signal from the antenna to the screen or to a TV converter/receiver. In an exemplary embodiment of the disclosure, the cable 640 is connected directly to a screen 680 or TV convertor/receiver without a matching circuit to control resistance of the antenna, since antenna design 630 is sized to match the wavelengths of the broadcast signals.

In an exemplary embodiment of the disclosure, the shape of the repetitive pattern 670 is of a polygonal spiral that is rotationally symmetrical (e.g. can be rotated 180 degrees and remain the same shape similar to a yin yang pattern). Optionally, pattern 670 is repeated multiple times (e.g. two, three, four, five or more times) along the length of the antenna design 630.

FIG. 6B is a schematic illustration of a deployed meander line antenna design 630 on the back of screen 680, according to an exemplary embodiment of the disclosure. Optionally, the antenna design 630 is designed to conform to the wavelengths of television and/or radio transmissions and the dimensions of the antenna design 630 are shorter than the size of the screen 680 to which it is attached (e.g. between 10-100 cm in length by 1-10 cm in width). Optionally, the thickness may be about 1-5 mm.

In some embodiments of the disclosure, the antenna design 630 is formed by cutting out portions from a flat sheet of material (e.g. a metallic sheet) instead of folding up a metallic line.

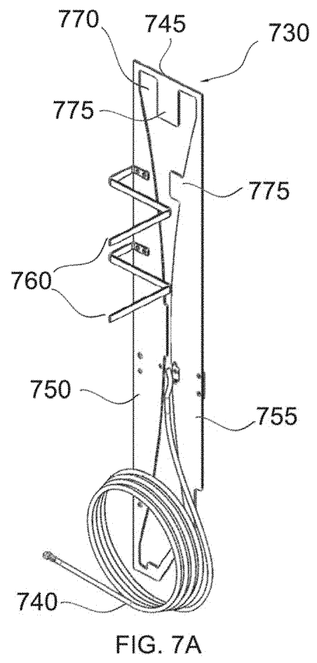

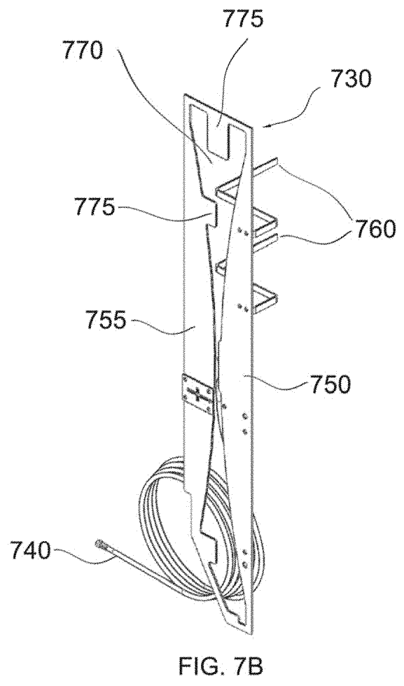

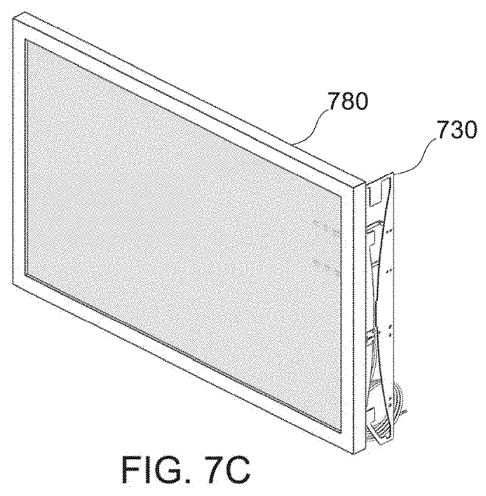

FIG. 7A is a schematic illustration of a back view of an antenna design 730 that serves as a directional antenna, and FIG. 7B is a schematic illustration of a front view of antenna design 730, according to an exemplary embodiment of the disclosure. Optionally, antenna design 730 may be installed in a wall mount (e.g. 200, 300, 400, 500) for example as part of the arm (e.g. 250, 350, 430, 550) between the mounting base (e.g. 210, 310, 410, 510) and the screen interface plate (e.g. 220, 320, 420). Alternatively, antenna design 730 may be used independent of a wall mount (e.g. 100, 200, 300, 400, 500) and installed directly on the back of a screen 780 (e.g. extending perpendicular to the back of the screen 780) or positioned between the back of the screen and the wall behind the screen. FIG. 7C is a schematic illustration of antenna design 730 deployed on the back of screen 780, according to an exemplary embodiment of the disclosure.

In an exemplary embodiment of the disclosure, antenna design 730 is a Vivaldi antenna formed as a planar sheet of metal forming a frame 745 surrounding a central cut out portion forming a void 770. Optionally, the frame 745 is essentially rectangular and designed to have two elongated arc shaped sides (750, 755) facing each other wherein in the center the arc shaped sides (750, 755) are almost tangent and the distance between the arc shaped sides (750, 755) increases when parting from the center toward the top and bottom edges of the frame 745. Optionally, in a few places the frame 745 includes inward teeth shaped protrusions, protruding into the void 770 to enhance reception.

In an exemplary embodiment of the disclosure, a cable 740 is attached to one of the arcs (750, 755), for example approximately at the center, to provide a signal from the antenna design 730 to screen 780 or a television converter/receiver. Optionally, one or more feelers 760 are coupled to the frame 745 to improve the antenna gain. Optionally, the feelers 760 extend upward from the plane of the antenna frame 745. The feelers 760 may be designed to touch the back of the screen when the antenna design 730 is deployed perpendicular to the screen as shown in FIG. 7C.

In an exemplary embodiment of the disclosure, the antenna design 730 is designed to conform to the wavelengths of television and/or radio transmissions and the dimensions of the antenna design 730 are shorter than the size of the screen 780 to which it is attached (e.g. between 10-100 cm in length by 1-10 cm in width). Optionally, the thickness of frame 745 may be about 0.5-5 mm.

In an exemplary embodiment of the disclosure, the cable 740 is connected directly to the screen or TV convertor/receiver without a matching circuit to control resistance of the antenna, since antenna design 730 is sized to match the wavelengths of the broadcast signals.

In some embodiments of the disclosure, the antenna design 730 includes an attachment piece 790 for attaching the cable 740 to the antenna design 730 and/or to attach the antenna design 730 to the screen 780.

In some embodiments of the disclosure, the antenna design (630, 730) is covered entirely or partially to enhance appearance, conceal the shape or protect the antenna design (630, 730). Optionally, the cover may be made from plastic, cloth or other non-conductive materials that do not interfere with the reception of the antenna.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/We claim:

1. A directional antenna, comprising
An antenna design configured to receive television or radio broadcast signals while positioned behind a screen that blocks reception of the broadcast signals;
Wherein the antenna design is configured to be attached directly or indirectly to the screen and receive broadcast signals from a direction perpendicular to the signals blocked by the screen.

2. The directional antenna of claim 1, wherein the antenna design is a Meander line antenna confined to a single plane.

3. The directional antenna of claim 2, wherein the antenna design includes an opening part with a cross shape formed by an intersections of two lines.

4. The directional antenna of claim 3, wherein one of the lines extends from the opening part and is folded to form an elongated series of a repetitive pattern.

5. The directional antenna of claim 4, wherein the repetitive pattern is shaped as a polygonal spiral that is rotationally symmetrical.

6. The directional antenna of claim 4, wherein the repetitive pattern is repeated multiple times.

7. The directional antenna of claim 1, wherein the antenna design is configured to be attached directly to the back of a screen that is bigger than the antenna.

8. The directional antenna of claim 1, wherein the antenna design is configured to be attached to a wall as part of a mounting base of a wall mount for supporting a screen.

9. The directional antenna of claim 1, wherein the antenna design is configured to be attached to a screen as part of a screen interface frame of a wall mount for supporting a screen.

10. The directional antenna of claim 1, wherein the antenna design is formed by folding a line of metal.

11. The directional antenna of claim 1, wherein the antenna design is formed by cutting out portions from a flat sheet of metal.

12. The directional antenna of claim 1, wherein a cable is attached to the antenna design to provide a signal from the antenna to the screen or to a television convertor or television receiver.

13. The directional antenna of claim 1, wherein the antenna design is configured to be attached to the back of a screen and extend outward perpendicular to the back of the screen.

14. The directional antenna of claim 1, wherein the antenna design is configured to be attached to a screen as part of an arm of a wall mount for supporting a screen.

15. The directional antenna of claim 1, wherein the antenna design is a Vivaldi antenna provided as a planar sheet of metal forming a frame surrounding a central cut out portion forming a void.

16. The directional antenna of claim 15, wherein the frame is essentially rectangular and includes two elongated arc shaped sides facing each other wherein in the center the arc shaped sides are almost tangent and the distance between the arc shaped sides increases when parting from the center toward the top or bottom edges of the frame.

17. The directional antenna of claim 16, wherein the frame includes one or more inward teeth shaped protrusions, protruding from the frame into the void.

18. A method of receiving television or radio broadcast signals, comprising:
attaching a directional antenna directly or indirectly to a back of a screen that blocks reception of the signals;
wherein the directional antenna has an antenna design that is configured to receive broadcast signals from a direction perpendicular to the signals blocked by the screen.

19. The method of claim 18, wherein the antenna design is configured to be attached directly to the back of a screen that is bigger than the antenna.

20. The method of claim 18, wherein the antenna design is configured to be attached indirectly to a screen as part of a wall mount that supports the screen.
